(19) United States
(12) Patent Application Publication
(10) Pub. No.: US 2026/0086651 A1
(43) Pub. Date: Mar. 26, 2026

(54) SYSTEMS AND DEVICES TO INFER HAND GESTURES AND OTHER HAND INTERACTIONS

(71) Applicants: Troy McDaniel, Gilbert, AZ (US); Yatiraj Shetty, Tempe, AZ (US)

(72) Inventors: Troy McDaniel, Gilbert, AZ (US); Yatiraj Shetty, Tempe, AZ (US)

(73) Assignee: Arizona Board of Regents on Behalf of Arizona State University, Tempe, AZ (US)

(21) Appl. No.: 19/340,345

(22) Filed: Sep. 25, 2025

Related U.S. Application Data
(60) Provisional application No. 63/699,036, filed on Sep. 25, 2024.

(51) Int. Cl. G06F 3/01; G01B 11/22; G01S 17/894; G06V 10/70; G06V 40/20; G10K 11/00; H04R 1/08

(52) U.S. Cl. CPC G06F 3/017; G01B 11/22; G01S 17/894; G06F 3/011; G06V 10/70; G06V 40/28; G10K 11/002; H04R 1/08

(57) ABSTRACT

Wearable devices are disclosed for interpreting hand interactions and other gestures. Specific examples include a ring-shaped device wearable along a finger and a wrist-worn device. Each of the example devices utilizes one or more sensors for acquiring acoustic signals and depth information, and at least one processor that uses this information to detect movements associated with the hand.

### CROSS-REFERENCE TO RELATED APPLICATIONS

This is a non-provisional application that claims benefit to U.S. Provisional Patent Application Ser. No. 63/699,036 filed 25 Sep. 2024, which is herein incorporated by reference in its entirety.

### GOVERNMENT SUPPORT

This invention was made with government support under 2142774 awarded by the National Science Foundation. The government has certain rights in the invention.

### FIELD

The present disclosure generally relates to wearable device and gesture recognition systems; and in particular to examples for wearable devices that use acoustic signals and depth to infer hand interactions.

### BACKGROUND

Hand gesture recognition is an extensively researched field where various sensing modalities have been proposed to infer hand gestures, actions, and object interactions. Wearable devices continue to gain popularity for gesture recognition but certain technical problems persist. For example, wrist-worn sensors often encounter the sensor-shift issue, requiring frequent calibration when the device is removed and re-worn. Though various innovative sensing strategies have been proposed before (like using IMUs, electrical techniques), it is important to note that camera-based techniques are still by far the most accurate; however, they suffer from three main issues: High processing requirements, occlusion, and privacy concerns.

It is with these observations in mind, among others, that various aspects of the present disclosure were conceived and developed.

### BRIEF DESCRIPTION OF THE DRAWINGS

FIG. 1A is a photograph of an example of a device for inferring a hand gesture/interaction described herein mounted on a wrist band.

FIG. 1B is a photograph of a top-view of the device of FIG. 1A.

FIG. 2 is a sampling of point clouds generated by the device of FIG. 1A.

FIG. 3A is a point cloud during a fist gesture when the field of view is not ‘compact.’

FIG. 3B is an illustration of the point cloud during fist gesture when the field of view is ‘compact.’

FIG. 4 is a point cloud during a finger pinch gesture; the view clearly shows the ellipticity of the shape through wrist view.

FIG. 5 is a simplified illustration of a novel wearable device designed in a wearable ring configuration that can accurately classify microgestures and other hand interactions.

FIG. 6 is a photograph of a specific example of the device of FIG. 5.

FIG. 7 is an enhanced view of the device of FIG. 6.

FIG. 8 is a photograph of an example data acquisition setup for the example of FIG. 6.

FIG. 9 is an illustration of example operations associated with the device of FIG. 6.

FIG. 10 is an illustration of the device of FIG. 6 demonstrating additional details.

FIG. 11 is a table highlighting features of the device of FIG. 6.

FIG. 12 is another illustration of the device of FIG. 6 demonstrating possible use of a customized microphone.

FIG. 13 is a schematic block diagram of an example computing device used in combination with the wearable device.

Corresponding reference characters indicate corresponding elements among the view of the drawings. The headings used in the figures do not limit the scope of the claims.

### DETAILED DESCRIPTION

The present disclosure relates to examples of wearable devices that implement one or more sensors for acquiring acoustic signals and depth information, and at least one processor that uses this information to detect movements associated with the hand.

In some aspects, the techniques described herein relate to a device for interpreting hand interactions and other gestures, including: a wearable body, including: a plurality of hardware components that generate data associated with a hand of a user, including: at least one sensor including a depth sensor that captures depth information including depth images of the hand, and an acoustic signal device that receives one or more acoustic signals through the hand; and a processor having access to the data, the processor configured to combine the depth information and the one or more acoustic signals to infer an interaction associated with the hand.

In further aspects, the techniques described herein relate to a method for inferring hand gestures and hand states using a wearable device, including: receiving, at a depth sensor, a plurality of low-resolution depth images of a hand of a user; processing, with a processor, the plurality of low-resolution depth images to generate a 3-dimensional representation of the hand; receiving, at an acoustic signal device, a plurality of bioacoustic vibration signals, wherein the bioacoustic vibration signals are propagated through the hand; inferring, by the processor, a hand gesture or state using a machine learning algorithm based on the 3-dimensional representation of the hand and the plurality of bioacoustic vibration signals.

In yet further aspects, the techniques described herein relate to a wearable device, including: a body configured for a user to wear on a finger; a 2-dimensional 8×8 time of flight (TOF) depth sensor attached to the body, wherein the depth sensor collects depth data depicting a plurality of finger microgestures, wherein the depth data includes a point cloud representation; a microphone attached to the body, wherein the microphone includes a membrane covering a port hole of the microphone, wherein the microphone is operable to receive one or more acoustic signals through a hand of the user and exclude ambient noise; and a processor operable to combine the point cloud representation and acoustic signals and infer, using a machine learning model, the plurality of finger microgestures.

Current hand tracking methods suffer from three main issues: High processing requirements, occlusion, and privacy concerns. The current device intends to balance all these concerns by providing a solution that uses a single low-resolution depth sensor that has significantly low processing requirements that camera and does not record any intelligible objects or background information (which mitigated privacy concerns). Though there is still the problem of occlusion but it does not affect the efficacy of this device for intended use cases: gesture recognition, tracking and hand action inferences.

Use of low-resolution depth sensors have been demonstrated. Some researchers have used set ups requiring multiple depth sensors to generate very accurate hand and arm tracking. But the instant device can use a single sensor to perform the hand recognition and inference tasks intended for its use. Because of this, the device may operate at a higher update rate while being sufficiently accurate. Other researchers have used two IR sensor and microphone to cleverly infer midair gestures. However, the two optical sensors only tracked general direction (not 3D shape of hand) of thumb movements and the system primarily used a microphone to track continuous figure actions. One other microphone used in another study suffered from limited bandwidth.

### (1) Wrist-Worn Wearable Device that can Infer Hand Interactions by Fusing Depth Sensing and Bioacoustics

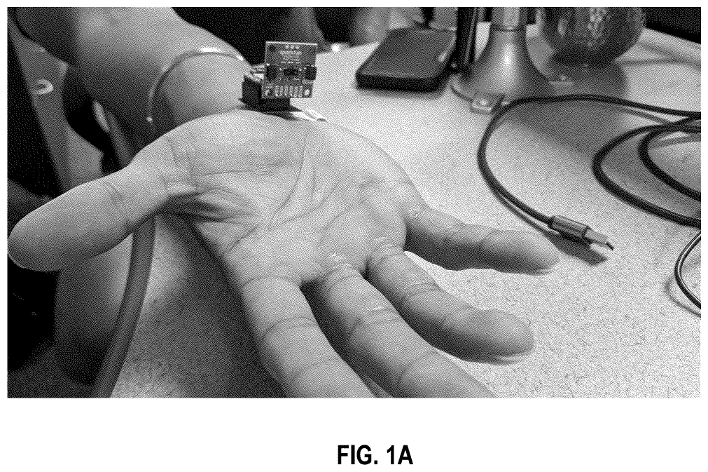

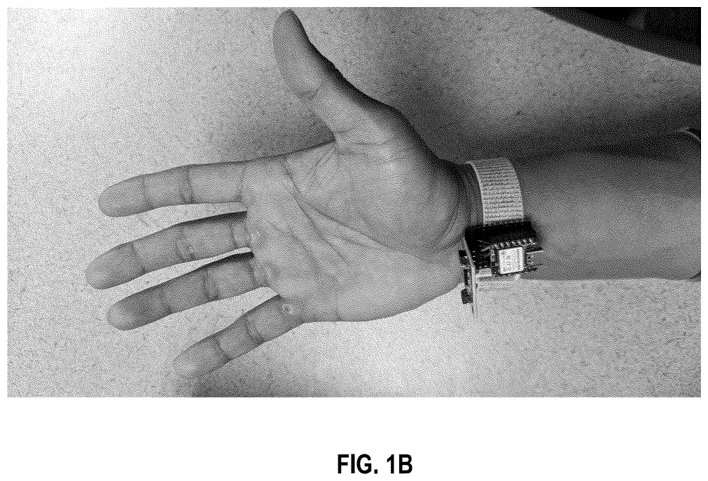

One example wearable device includes a novel gesture tracking device with the capability of accurately classifying discrete and continuous hand gestures and actions. Mounted on a wristband, the device incorporates a 2D 8×8 time of flight (TOF) sensor and an acoustic vibration sensor, both controlled by a small microcontroller. This wrist-mounted device is depicted in FIGS. 1A-1B. Leveraging the TOF sensor, the device generates a 3D representation of the hand region of interest within a 45-degree field of view (FOV) from the acquired depth data. In some examples, the TOF sensor is configured with a limited field of view such that the TOF sensor and the wearable device can infer certain gestures even with a limited resolution and FOV. In some examples, TOF sensor is configured with low resolution (64-pixel depth image). Regardless, with a limited field of view from the TOF sensor, the transformed data captures intricate details of hand deformations, enabling precise inferences through standard machine learning algorithms. In addition to depth sensing, the device captures bioacoustic vibration signals propagating through the hand, detected by the acoustic vibration sensor. This multimodal approach enhances the device's capabilities, opening avenues for intuitive applications, such as gesture-based control of smart devices or cameras.

### Introduction

The present gesture tracking device may include two key sensors: a Time-of-Flight (TOF) 8×8 multizone ranging sensor (e.g. VL53L5CX) and a Voice Pickup Unit (VPU) from Sonion (e.g. VPU14DB01). The device is powered by a high-performance microcontroller for data acquisition. The acquired data can be transmitted via USB C serial connection or Bluetooth low energy protocol.

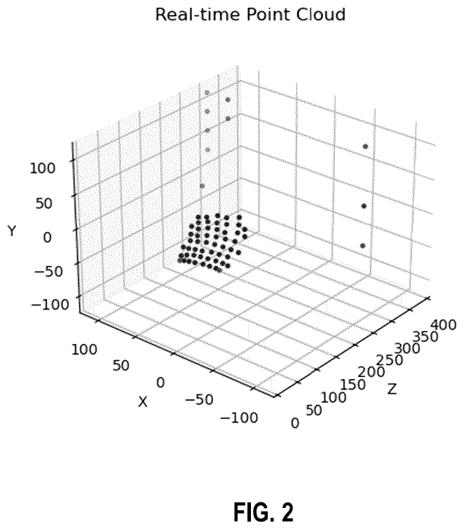

The primary goal of this device is not comprehensive hand gesture tracking but rather the inference of hand states within a limited field of view of 45 degrees. To achieve this, machine learning is leveraged on multimodal sensing data generated by the system. The low-resolution 2D image of the hand captured by the TOF sensor was utilized to generate point cloud data. An exemplary point cloud sample is depicted in FIG. 2. This gives important information about the hand shape in 3D. The VPU plays a crucial role in capturing relevant audio signals, as vibrations generated during gestures and hand-object interactions are notoriously noisy but the VPU's hermetically sealed design ensures superior robustness to background noise, providing higher signal-to-noise ratio (SNR) than current systems.

Wrist-worn sensors often encounter the sensor-shift issue, requiring frequent calibration when the device is removed and re-worn. To address this challenge, the inventive concept incorporates a calibration algorithm that analyzes the shapes generated by the point clouds and guides the user to maintain a consistent location of the sensor relative to the hand region of interest. This calibration process ensures reliable and precise tracking of hand actions.

The intended application of this device is as a new form of controller for gesture-based interfaces, ensuring an enhanced user experience while prioritizing user privacy. Privacy concerns are mitigated by the limited range and resolution of the TOF sensor. Additionally, the technology is envisioned to complement previous inventive concepts, such as SleeveSight (a smart haptic sleeve) and Peractiv (a smart wrist camera), thereby enhancing their sensing capabilities.

### Device Example Details

The gesture tracking device may be operable to accurately capture hand interactions, including both discrete gestures and continuous hand actions, with the aim of providing intuitive gesture-based control for smart devices and cameras. The device is compact and wrist-worn, making it portable and convenient for everyday use. The device is based on principles of multimodal sensing and combines depth information (from TOF sensor) and bioacoustic information (from the VPU) to generate accurate inferences: (1) dynamic hand gestures (2) microgestures in mid-air or when grasping objects, and/or (3) object detection.

### Components

Time-of-Flight (TOF) Sensor: The core sensing element of the device includes the 2D 8×8 multizone ranging TOF sensor (e.g. VL53L5CX). This sensor is strategically placed on the ventral side of the wrist, within a wrist band. The TOF sensor captures low-resolution 2D depth images of the hand within a limited field of view of 45 degrees. In some embodiments, a depth image is considered to be low-resolution where it has a pixel depth of about 64-pixels. In other embodiments, a depth image is considered to be low-resolution where it has a pixel depth of about 64-pixels or less. For example, the depth image is low-resolution where it has a pixel depth of about 64-pixels or less, about 60-pixels or less, about 55-pixels or less, about 50-pixels or less, about 45-pixels or less, about 40-pixels or less, about 35-pixels or less, about 30-pixels or less, about 25-pixels or less, or about 20 pixels or less.

Voice Pickup Unit (VPU): The device also incorporates a Voice Pickup Unit (e.g. VPU14DB01) from Sonion, which functions as an acoustic vibration sensor. The VPU is hermetically sealed to ensure robustness against background noise and can capture relevant audio signals that propagate through the hand during gestures and hand-object interactions. Because this sensor functions like a contact microphone the environmental noise travelling through air is not picked up by the device. This ensures that the signals acquired through VPU have high SNR.

Microcontroller: Data acquisition and processing are managed by a high-performance microcontroller with an in-built IMU (e.g. seed studio xiao nrf52840 sense). The microcontroller serves as the central processing unit, facilitating the conversion and fusion of data from the TOF sensor and VPU. Though in the current format the IMU signals were not used, it is important to note that interesting applications could be built by combining this with existing signals from the system.

### Device Fabrication and Assembly

In one embodiment, the inventive concept is assembled into a wrist band, allowing for easy and comfortable wearability on the wrist. The TOF sensor and VPU may be carefully integrated into the wrist band to ensure optimal sensor placement for accurate data capture. In some applications, the TOF may be set in a position in the volar region of wrist to ensure good view of hand. The VPU may be directly attached to the skin to pick up bioacoustic signals emanating from hand interactions (gesture and hand-object interactions). In further embodiments, the microcontroller is securely housed within the wrist band, including necessary circuitry for data transmission.

### Sensor Fusion and Data Processing

Upon activation, the TOF sensor may capture depth data, converting it into a point cloud representing the 3D shape of the hand region of interest. In some embodiments the depth data is converted to a point cloud by the microcontroller or a processor in communication with the TOF sensor. In some embodiments, the point cloud is a 2D point cloud which is subsequently utilized to generate a 3D representation of the hand's position and deformation. In other embodiments, the point cloud is a 3D point cloud representing the hand's position and deformation or may be used to generate an additional 3D representation of the hand's position and deformation. In some applications, the TOF sensor, microcontroller, or processor may infer portions of the hand in the 3D representation of the hand using the captured depth data and point cloud. In further applications, the TOF sensor may be positioned on the volar side of the wrist, permitting the system to gain a comprehensive view of thumb-to-finger interactions, facilitating accurate inferences on dynamic hand gestures after appropriate training.

Concurrently, the VPU may capture bioacoustic vibration signals generated during hand interactions. In some embodiments, the VPU may detect one or both of two types of bioacoustic signals: (1) surface acoustic waves resulting from contact friction between fingers and/or held objects or surfaces, and (2) mechanomyography (MMG) signals generated by muscle fibers during hand gestures. In some embodiments, the VPU is hermetically sealed to prevent interference or noise pollution from vibrations in the ambient air. Where the VPU is hermetically sealed, the system may be agnostic to or filter out ambient sounds.

In some embodiments, the utilization of both TOF and VPU signals may allow for hand gesture detection even when the TOF sensor is occluded by an object. Remarkably, during research, it was observed that the device could capture microgestures performed during mid-air gestures and grasped object scenarios. The microcontroller may receive data streams from both the TOF sensor and VPU and processes them using standard machine learning algorithms to infer the hand's position and gesturing. By using both the TOF sensor and VPU, the microcontroller may feed the data to a machine learning model trained to infer the position and deformation of a hand where one of the sensor's data is obscured or interrupted. This multimodal sensor fusion enhances the accuracy and robustness of hand interaction detection, enabling the device to precisely infer minute hand gestures and actions.

For example, electromyography (EMG) has been shown to be used for object detection through hand shape analysis. But usually this is reported in isolated experiments. The present device acquires MMG signals, surface acoustic waves resulting from finger interactions, and hand shape data from the TOF sensor, making it capable of performing object detection among other features.

### Calibration Algorithm

The calibration algorithm addresses two issues: (1) Maximum utilization of the field of view of TOF sensor; and (2) the sensor-shift issue is commonly encountered in wrist-worn sensors.

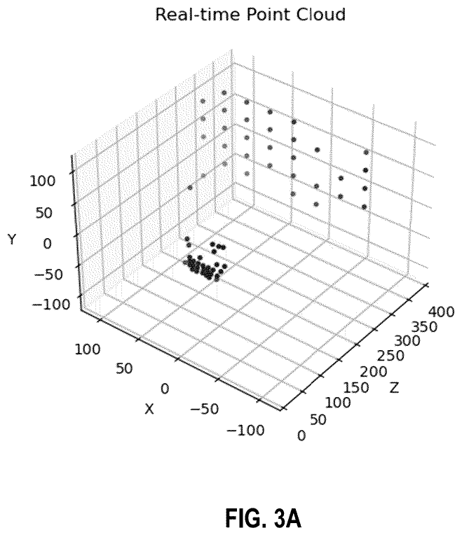

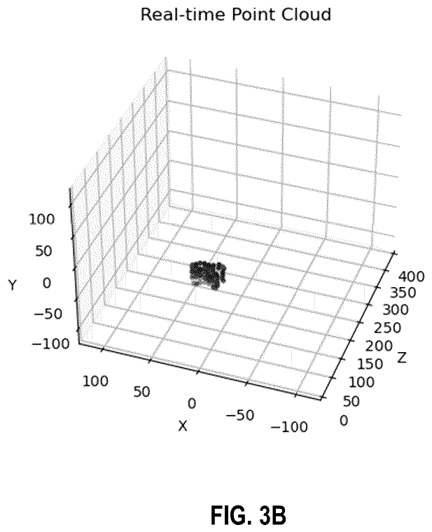

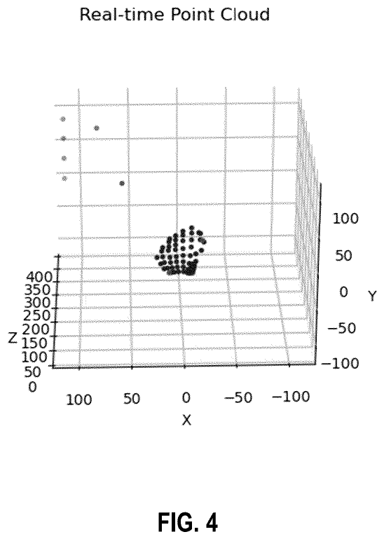

An important observation seen during pilot studies was that during a specific hand gesture (for example fist gesture—chosen because it is the smallest shape that utilized entire hand), the coverage of the point cloud is not complete i.e. less ‘compact’ if the sensor is not positioned optimally. The coverage of the point cloud of the fist gesture is depicted in FIG. 3A. Theoretically to maximize resolution within a limited FOV it is important to discriminate the maximum variance is shape possible. Hence if one can guide the positioning of the sensor such that the point cloud is more compact (shown in FIG. 3B) one would be able to track more minute details when continuous hand gestures are performed. Similarly, it can be noted that the inclination of the shape is different for different point cloud shape, this is shown in FIG. 4.

The calibration algorithm may analyze the shapes (convex hull) generated by the point clouds and provide feedback to the user to ensure a consistent location of the sensor relative to the hand region of interest based on shape descriptors (compactness, hull centroid distance and ellipticity) generated. Initially, the user may be asked to perform a simple gesture such as a fist or pinched fingers. The shape descriptors generated for this are unique and change predictably when the device is moved along the hand (longitudinal) or across the hand (lateral). Hence, the shape descriptors can be used to place the sensor consistently in the correct location and relocate the sensor to the correct location if it moves. Calibration enhances the device's stability and accuracy, making it less susceptible to position variations caused by removal and re-wearing of the device

Summary of Wrist-worn Embodiment: The present device may be a wrist-worn gesture tracking device that combines depth sensing and bioacoustic signals to accurately infer complex hand interactions. The device may incorporate a 2D time-of-flight (TOF) sensor and an acoustic vibration sensor to capture depth data and bioacoustic vibrations emanating from hand interactions, respectively. Thus, by leveraging both direct line-of-sight sensing and indirect physiological signal sensing, the inventive device aims to surpass the limitations of individual sensing methodologies and offer a robust approach to hand interaction detection. One aim is to strike a harmonious balance between functionality, wearability, and privacy, while effectively capturing the intricate expressivity of hand interactions.

The present gesture tracking device includes three main aspects: (1) Combining a 2D TOF sensor for depth sensing and acoustic vibration sensor to perform hand shape analysis and bioacoustic sensing; (2) a calibration algorithm to mitigate variations in device positioning with respect to hand; (3) using this sensing to perform complex inferences of continuous hand poses, microgestures and hand-object interactions like grasped object microgestures.

In comparison, a single optical sensor and a single acoustic vibration sensor was used to perform similar inferences (and more complex inferences) and use only standard light weight algorithms. This, in future, could be easily incorporated into smartwatches or textile-based form-factors. This allows the on-board processor to focus on other actions, for example controlling devices and even trigger cameras as needed.

### Exemplary Applications

The gesture tracking device may be used as a new form of controller for smart devices and cameras. When worn on the wrist, it continuously captures hand interactions, detecting both discrete gestures and continuous hand actions. The captured data may then be processed and analyzed through machine learning algorithms to infer the intended hand states. The presently device has wide-ranging applications in human-computer interaction, enabling gesture-based control of smart devices, cameras, virtual reality environments, and interactive displays. Additionally, the device may be integrated with existing inventive concepts, such as SleeveSight (a smart haptic sleeve) and Peractiv (a smart wrist camera), to enhance their sensing capabilities and offer enriched user experiences.

A non-exhaustive list of areas for application of the present technology may include: (1) Enabling gesture inference on smart textiles; (2) enhancing hand gesture and action inferences on existing smartwatches; (3) enabling accurate control of camera action on wearable camera devices like Peractiv; (4) allowing better assistive control for people with low mobility; and (5) controller design for gaming applications.

In summary, the wrist worn gesture tracking device may enable intelligent gesture interfaces with low computational requirements. This can be impactful in the field of consumer electronics and medical devices.

### (2) Ring-Worn Wearable Device that can Fuse Depth and Acoustic Signals to Infer Hand Gestures and Other Hand Interactions

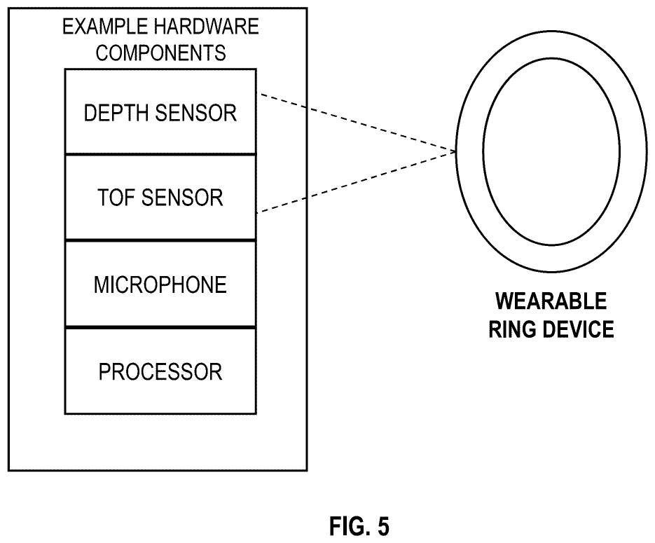

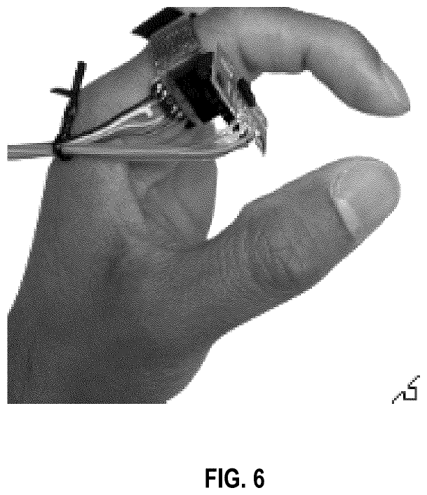

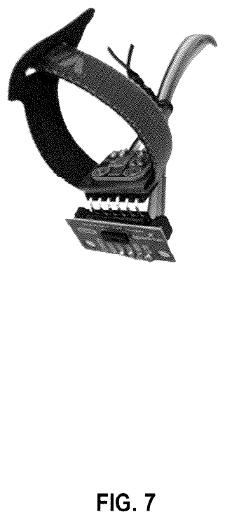

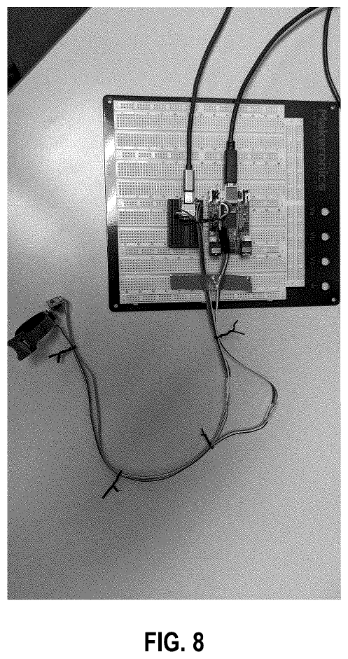

In a second embodiment, the present wearable device may be configured to be placed on the finger of a user in a ring format. An exemplary embodiment of the ring-worn device is depicted in FIGS. 5-8 The ring-worn device may be configured to track and accurately classify microgestures and other hand interactions. The device may include a depth sensor and a customized microphone mounted in a ring wearable format. By combining data from a low-resolution depth sensor and a customized microphone, subtle finger movements could be detected. A specific focus was made on detection of microgestures-subtle and continuous finger movements. In addition, the customized microphone may be sufficiently sensitive to detect vibrations from hand-held objects. In some embodiments, the vibrations from the hand-held objects may be used to classify the hand-held object. The low-resolution depth sensor may ensure that no background information is picked up other than the finger movements. The customized microphone may be operable to filter out or be agnostic to ambient sounds in the environment such that the microphone only picks up sound vibrations traveling through the skin. By excluding the detection of ambient sounds, the device may be privacy-preserving and sufficiently small to be used in everyday applications. In some examples, rather than implementing a customized microphone, vibration sensors may be implemented to detect the vibrations traveling through the skin while still preventing the capture ambient noise as much as possible.

### Introduction

The ring-worn gesture tracking device may comprise two key sensors: a Time-of-Flight (TOF) 8×8 multizone ranging sensor (e.g. VL53L5CX) and a customized PDM microphone. The PDM microphone may be customized by sticking a membrane over the port hole to prevent picking up background noise and increase the SNR. In some embodiments, the membrane may include a metal tape such as a copper tape. In one example, the data from the TOF sensor may be acquired using a microcontroller (e.g. xiao nrf52840 sense) and the data from the microphone may be acquired using an audio processor module (e.g. miniDSP MCHStreamer Kit). In further embodiments, all processing may be handled on board using an internal processor or microcontroller to make the ring wearable and portable. In yet further embodiments, all processing may be handled wirelessly using an external computing device in wireless communication with the ring-worn device to make the ring wearable and portable.

In one embodiment, the depth sensor may be used to view finger movement of a user. In some aspects, the update rate of the TOF depth sensor may be about 15 Hz while still being sufficient to discriminate selected microgestures. Because it was noticed that there were instances when the direct contact detection of fore finger to thumb was missing when only using the TOF depth sensor, it was decided to augment the TOF sensor with the use of vibration sensors. Although there are multitude of options that may be used for the vibration sensor such as microphones and bone conduction sensors, a microphone was selected because of higher bandwidth.

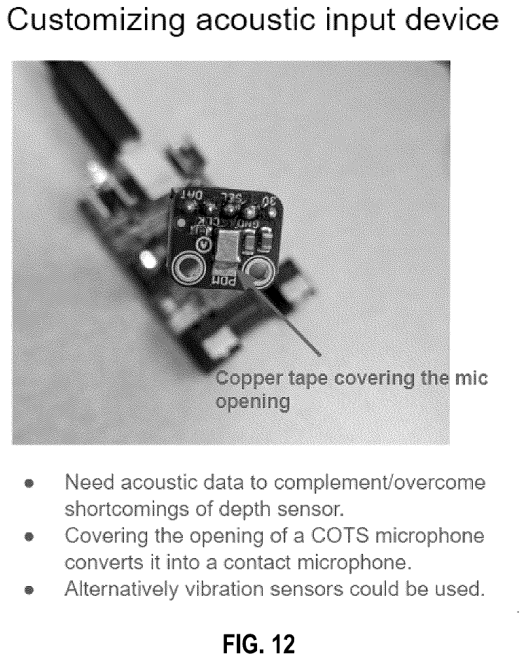

While Aluminum (Al) foil has been previously used with a microphone, the form-factor used by the prior research included covering the entire microphone module, FPC, and included a z-slot to compress the microphone to skin. This was done under the assumption that the presence of a large aluminum foil converted the microphone into a stethoscope-like diaphragm and prevented ambient noise detection due to skin capacitance. In contrast, it was discovered that simply covering the port-hole of the microphone improves the SNR sufficient for the present purposes. The modification to the microphone is depicted in FIG. 12. It was further discovered that in some embodiments, a non-metallic film may be used to cover the port-hole (e.g. plastic tape). It was found that as long as the vibration travelling through skin is properly segmented and the ambient noise is reasonably attenuated, microphones may be used for gesture inference. It was also found that the microphone is sensitive enough to discriminate the frequencies from energized objects like hair dryer, etc. Though this capability was demonstrated previously using accelerometers in HCl literature, an example of using microphones for this task was not known or found.

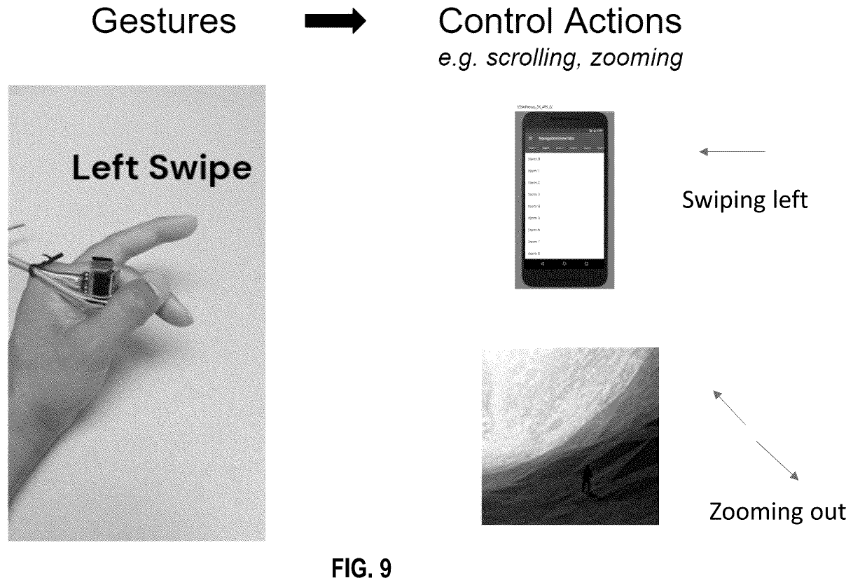

In some applications, the present device presents a new form factor (ring) of a controller for gesture-based interfaces, ensuring an enhanced user experience while prioritizing user privacy. An example application of the device is depicted in FIG. 9. Privacy concerns are mitigated by the limited range and resolution of the TOF sensor, rather than using an RGB camera. Privacy concerns are further mitigated by the use of a customized microphone that does not pick up ambient sounds.

### Ring Device Example Details

The present ring-wearable device may include a depth sensor in combination with a microphone for inferring certain hand or finger gestures and even energized objects. The gesture recognition space of the present device may include: (1) microgestures in mid-air or when grasping objects, and (2) object detection.

### Components of the Ring-Worn Embodiment

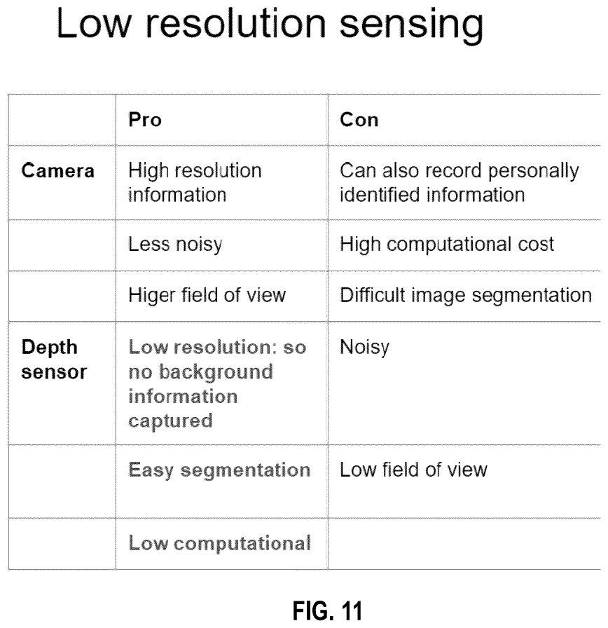

Time-of-Flight (TOF) Sensor: The core sensing element of the device may include the 2D 8×8 multizone ranging TOF sensor (e.g. VL53L5CX). This sensor may be strategically placed on the forefinger using a velcro strap or other securing mechanism. The TOF sensor may be operable to capture low-resolution 2D depth images of the fingers within a limited field of view of 45 degrees. In some embodiments, a depth image may be considered “low-resolution” when it has a pixel depth of about 64-pixels. In some embodiments, a depth image may be considered “low-resolution” when it has a pixel depth of less than about 64-pixels. By utilizing low resolution depth-images, the present device does not capture sensitive background information. Advantages of the usage of low-resolution sensing with a depth sensor are outlined in FIG. 11.

Voice Pickup Unit (VPU): The present device may further incorporate a customized microphone (using a copper tape or a plastic tape over the porthole). Customization of the microphone is done to reduce unwanted background noise and ensure high SNR.

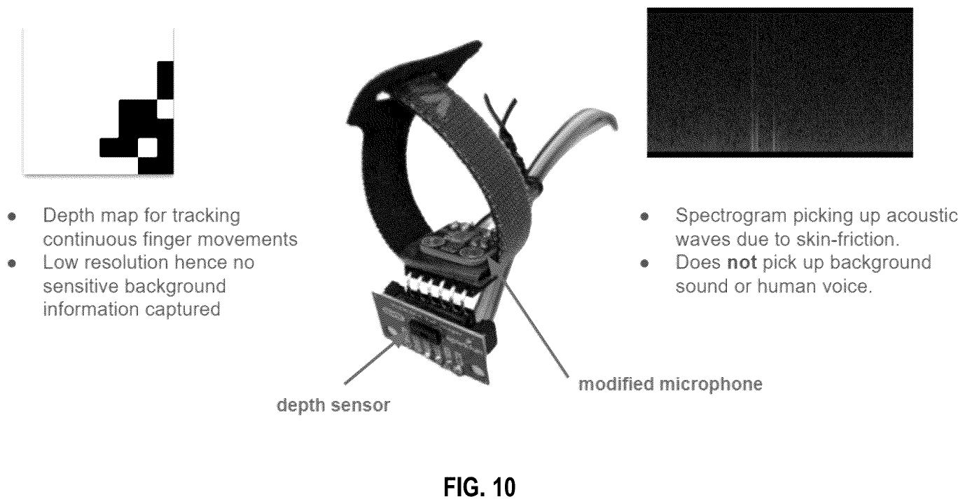

Microcontrollers: The depth data may be acquired using a microcontroller (e.g. xiao nrf52840 sense) at 15 Hz. The audio data may be acquired using an audio processing module (e.g. miniDSP MCHStreamer Kit) at 48 kHz. A python script may handle the entire data acquisition process. The components of the ring-worn embodiment are highlighted in FIG. 10.

### Device Fabrication and Assembly

The ring wearable form factor ensures that the depth sensor has full view of the fingers and is able to measure microgestures of the fingers. During testing, it was noticed that it may be worthwhile to include a vibration sensor attached to the finger to improve the quality of classification of certain gestures.

### Sensor Fusion and Data Processing

In some applications, the data from depth sensor and audio sensor may be processed to generate useful inferences using machine learning algorithms. In further applications, these useful inferences may include inferring a hand position, gesture, or occluded portion of the hand. In yet further applications, the present device may utilize the unique acoustic signatures detected from an object held in a user's hand to perform object detection using a machine learning algorithm.

### Example Inventive Features

In general, the present ring-worn gesture tracking device may fuse depth sensing and acoustic signals to infer microgestures and recognize energized hand-held objects. The device incorporates a 2D time-of-flight (TOF) sensor and an acoustic vibration sensor to capture depth data and bioacoustic vibrations emanating from hand interactions, respectively. In specific applications, the sensors may be utilized to view finger interactions called microgestures and detect vibrations of held objects to classify them. By leveraging both direct line-of-sight sensing and indirect physiological signal sensing, one aim of the subject device may be to surpass the limitations of individual sensing methodologies and offer a robust approach to hand interaction detection.

### Advantages and Example Applications

The use of wearable rings for finger gesture recognition is an extensively researched field where various sensing modalities have been proposed to infer hand gestures, actions, and object interactions. Though various innovative sensing strategies have been proposed before in this research (such as using IMUs\ or electrical techniques), it is important to note that camera-based techniques are still by far the most accurate. However, camera-based techniques suffer from three main issues: high processing requirements, occlusion, and privacy concerns. The present device balances all these concerns by providing a solution that (1) uses a single low resolution depth sensor that has significantly low processing requirements than camera-based techniques, and (2) mitigates privacy concerns by not recording intelligible objects or background information. While the problem of occlusion may still exist, it does not affect the efficacy of the present device for gesture recognition, tracking, hand action inferences, and object detection.

In contrast to ring worn devices in the literature, a single optical sensor and a single acoustic vibration sensor may be used with the present device to perform both simple and complex inferences while only utilizing standard light weight algorithms. In some applications, the gesture tracking device may used as a form of controller for smart devices, cameras, or other devices in a wearable ring form factor. Further applications of the present gesture tracking device may include applications in human-computer interaction, enabling gesture-based control of smart devices, cameras, virtual reality environments, and interactive displays. Further technological areas for application of the present technology may include assistive control for people with motor and visual impairments and controller design for gaming applications.

In summary, the ring worn gesture tracking device may function to enable intelligent gesture interfaces with low computational requirements and may be impactful in the field of consumer electronics and medical devices.

### Comparison of Wrist-Worn and Ring-Worn Devices

Examples herein include a ring-shaped finger worn device, and a wrist-worn device. Similarities between the wrist-worn device and ring-worn device may include:
Both the devices may utilize the same sensors (depth and audio) such that the raw input is the same for both devices. However, the processing system between the two devices is different due to the change in location.
The reason for using this combination of sensors is to leverage the complementary nature of sensor data i.e. when one sensor does not have enough information, the other sensor can help. For example, during a pinch gesture, even if the depth sensor cannot see the pinch, the audio sensor can ‘hear’ it.
Example applications like object detection may be done at the wrist or ring position and only require leveraging the microphones as the audio sensor.

Differences between the wrist-worn device and ring-worn device may include:
Location (wrist vs. finger)
The wrist-worn device predominantly looks at the deformation of the thenar region of the palm whereas the ring device directly looks at the fingers (especially the index finger and thumb). This necessitates different training data for the machine learning algorithms used for each device.
For wrist-worn devices calibration is required to ensure the placement is approximately the same. The ring-worn device may be manually set at the right angle without any calibration because the finger-tips can be easily seen.
The range of detectable gestures may differ between ring and wrist-worn devices due to the difference in data. This needs to be seen in further research.

The above clarifications are provided merely for organizational purposes. It should be understood that features of the ring example may be implemented via the wrist-worn example, and vice versa, and such further examples are fully within the spirit and scope of the instant inventive disclosure.

### (3) Computer-Implemented System

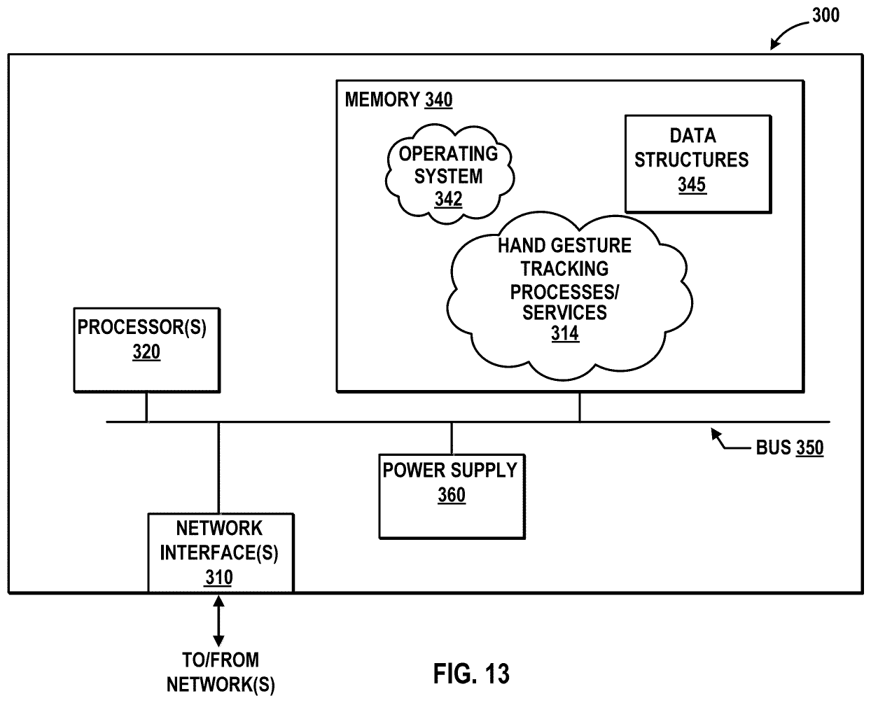

FIG. 13 is a schematic block diagram of an example computing device 300 that may be used with one or more embodiments described herein, e.g., as a component of the wearable gesture tracking device.

Device 300 comprises one or more network interfaces 310 (e.g., wired, wireless, PLC, etc.), at least one processor 320, and a memory 340 interconnected by a system bus 350, as well as a power supply 360 (e.g., battery, plug-in, etc.).

Network interface(s) 310 include the mechanical, electrical, and signaling circuitry for communicating data over the communication links coupled to a communication network. Network interfaces 310 are configured to transmit and/or receive data using a variety of different communication protocols. As illustrated, the box representing network interfaces 310 is shown for simplicity, and it is appreciated that such interfaces may represent different types of network connections such as wireless and wired (physical) connections. Network interfaces 310 are shown separately from power supply 360, however it is appreciated that the interfaces that support PLC protocols may communicate through power supply 360 and/or may be an integral component coupled to power supply 360.

Memory 340 includes a plurality of storage locations that are addressable by processor 320 and network interfaces 310 for storing software programs and data structures associated with the embodiments described herein. In some embodiments, device 300 may have limited memory or no memory (e.g., no memory for storage other than for programs/processes operating on the device and associated caches).

Processor 320 comprises hardware elements or logic adapted to execute the software programs (e.g., instructions) and manipulate data structures 345. An operating system 342, portions of which are typically resident in memory 340 and executed by the processor, functionally organizes device 300 by, inter alia, invoking operations in support of software processes and/or services executing on the device. These software processes and/or services may include hand gesture tracking processes/services 314 described herein. Note that while hand gesture tracking processes/services 314 is illustrated in centralized memory 340, alternative embodiments provide for the process to be operated within the network interfaces 310, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the hand gesture tracking processes/services 314 is shown as a standalone process, those skilled in the art will appreciate that this process may be executed as a routine or module within other processes.

It should be understood from the foregoing that, while particular embodiments have been illustrated and described, various modifications can be made thereto without departing from the spirit and scope of the inventive concept as will be apparent to those skilled in the art. Such changes and modifications are within the scope and teachings of this inventive concept as defined in the claims appended hereto.

What is claimed is:

1. A device for interpreting hand interactions and other gestures, comprising:
a wearable body, including:
a plurality of hardware components that generate data associated with a hand of a user, comprising:
at least one sensor including a depth sensor that captures depth information comprising depth images of the hand, and
an acoustic signal device that receives one or more acoustic signals through the hand; and
a processor having access to the data, the processor configured to combine the depth information and the one or more acoustic signals to infer an interaction associated with the hand.

2. The device of claim 1, wherein the wearable body is mounted to a wrist of the user.

3. The device of claim 1, wherein the wearable body includes a ring configured for the user to wear on a finger.

4. The device of claim 1, wherein the depth sensor is a time of flight (TOF) sensor having a field of view of about 45°, the TOF sensor being operable to collect the depth information and generate low-resolution depth images of the hand.

5. The device of claim 1, wherein the depth sensor is operable to produce a point cloud representation of the hand from the depth information.

6. The device of claim 5, wherein the processor is operable to generate a 3-dimensional representation of the hand using the point cloud representation and depth information, and infer, using a machine learning model, a position, gesture, or region of the hand based on the 3-dimensional representation of the hand and the one or more acoustic signals.

7. The device of claim 4, wherein the low-resolution depth images are 64-pixel depth images.

8. The device of claim 2, wherein the depth sensor is positioned in a volar region of the hand.

9. The device of claim 1, wherein the acoustic signals include bioacoustics signals generated within the hand during gestures or hand-object interactions.

10. The device of claim 1, wherein the acoustic signal device includes a voice pickup unit (VPU) operable to capture bioacoustics signals propagated through the hand by hand gestures or hand-object interactions.

11. The device of claim 1, wherein the acoustic signal device is hermetically sealed such that the acoustic signal device captures bioacoustics signals propagated through the hand while excluding ambient noise and vibrations.

12. The device of claim 5, wherein the processor is operable to:
automatically detect, using a calibration algorithm, an improper placement of the depth sensor based on a plurality of shapes generated within the point cloud representation; and
generate a notification, of the improper placement of the depth sensor, wherein the notification guides the user to maintain a consistent location of the depth sensor.

13. The device of claim 1, wherein the acoustic signal device is a microphone positioned along the hand of the user, the microphone being operable to detect vibrations within the hand during gestures or hand-object interactions.

14. The device of claim 13, wherein a port hole of the microphone is covered with a membrane and wherein the microphone excludes ambient noise and vibrations.

15. The device of claim 14, wherein the membrane is a metal tape.

16. The device of claim 9, wherein the processor is operable to identify, using a machine learning model, a hand-held object based on the bioacoustic signals generated within the hand during the hand-object interactions.

17. A method for inferring hand gestures and hand states using a wearable device, comprising:
receiving, at a depth sensor, a plurality of low-resolution depth images of a hand of a user;
processing, with a processor, the plurality of low-resolution depth images to generate a 3-dimensional representation of the hand;
receiving, at an acoustic signal device, a plurality of bioacoustic vibration signals, wherein the bioacoustic vibration signals are propagated through the hand; and
inferring, by the processor, a hand gesture or state using a machine learning algorithm based on the 3-dimensional representation of the hand and the plurality of bioacoustic vibration signals.

18. The method of claim 17, wherein the depth sensor includes a 2-dimensional 8×8 time of flight (TOF) sensor, and wherein the depth sensor is positioned at a volar region of the hand.

19. The method of claim 17, wherein the acoustic signal device includes a microphone having a port hole covered with a metal membrane, wherein the microphone excludes ambient noise and vibrations.

20. A wearable device, comprising:
a body configured for a user to wear on a finger;
a 2-dimensional 8×8 time of flight (TOF) depth sensor attached to the body, wherein the depth sensor collects depth data depicting a plurality of finger microgestures, wherein the depth data includes a point cloud representation;
a microphone attached to the body, wherein the microphone includes a membrane covering a port hole of the microphone, wherein the microphone is operable to receive one or more acoustic signals through a hand of the user and exclude ambient noise; and
a processor operable to combine the point cloud representation and acoustic signals and infer, using a machine learning model, the plurality of finger microgestures.
